(19) United States
(12) Patent Application Publication
(10) Pub. No.: US 2017/0013803 A1
(43) Pub. Date: Jan. 19, 2017

(54) ANIMAL TUBE FEEDER

(71) Applicants: Bill Teinert, Hondo, TX (US); Benito Valdes, Eagle Pass, TX (US)

(72) Inventors: Bill Teinert, Hondo, TX (US); Benito Valdes, Eagle Pass, TX (US)

(21) Appl. No.: 15/205,988

(22) Filed: Jul. 8, 2016

Related U.S. Application Data
(60) Provisional application No. 62/189,930, filed on Jul. 8, 2015.

(51) Int. Cl. A01K 5/02

(52) U.S. Cl. CPC A01K 5/0225

(57) ABSTRACT

The animal tube feeder is an animal feeder for holding and dispensing animal feed. It has a hollow body that is generally tubular or polyhedral in shape. The bottom of the feeder is generally conical or pyrimidal in shape, but the surface is not regular, Instead, it has a series of ridges and surfaces that are sloped and shaped create feeding channels that allow gravity to urge the animal feed out of feeding tubes on the sides of the feeder. The feed is generally held in the tubes by a lip and allows animals to access the feed in the tubes.

This application is based upon and claims priority from U.S. Provisional application Ser. No. 62/189,930, which is incorporated herein by reference.

### BACKGROUND OF THE INVENTION

Field of the Invention

Applicants' invention relates to a gravity fed animal feeder. More particularly, it relates to an improved design of a gravity fed animal feeder that improves feed movement and dispersal.

Background Information

A common method of hunting involves using a feeder to entice deer to a specific location. A feeder provides a way for hunters and other enthusiasts to feed deer.

A healthy deer herd is one of the most important factors contributing to a successful hunting season.

### SUMMARY OF THE INVENTION

The current invention is an octagonal, or polyhedral, animal feeder. The octagon shape is from top to bottom of the feeder. The feeder itself is tubular, that is, it has a hollow interior to accept volumes of animal feeds or supplements. It is anticipated that the sorts of feeds that would be used through the octagonal feeder are corn, grain pellets, protein, and the like (collectively referred to as “animal feed”). The animal feed is stored in the interior of the octagonal feeder. The animal feed is moved into feeding tubes via gravity in the shape of the bottom of the feeder. As an animal such as a deer eats the animal feed, more of the animal feed is directed into the feeding tube where it is caught and held until eaten.

### BRIEF DESCRIPTION OF THE DRAWINGS

FIG. 1 is a perspective view of the improved feeder having four (4) feeding tubes.

FIG. 2 is a side view of the bottom of the improved feeder having four (4) feeding tubes.

FIG. 3 is a top view of the interior bottom of the improved feeder having four (4) feeding tubes.

FIG. 4 is a perspective view of the exterior bottom of the improved feeder.

FIG. 5 is a perspective view of a feeding tube opening.

FIG. 6 is a front view of a feeding tube opening.

FIG. 7 is a perspective view of the improved feeder having eight (8) feeding tubes.

FIG. 8 is a top view of the interior bottom of the improved feeder having eight (8) feeding tubes.

### DETAILED DESCRIPTION OF THE PREFERRED EMBODIMENT

| | |
|---|---|
| 10 | Feeder |
| 12 | Top |
| 14 | Plate Edge |
| 16 | Side Plate |
| 18 | Support Member |
| 20 | Leg |
| 22 | Runner |
| 24 | Foot |
| 30 | Tube |
| 32 | Front Edge |
| 34 | Side Plate Lip |
| 36 | Feeding Plate |
| 38 | Feed stop |
| 40 | Tube Side |
| 42 | Tube Top |
| 44 | Feed Aperture |
| 50 | Bottom |
| 52 | Apex |
| 54 | Top Ridge |
| 56 | Ridge Apex |
| 58 | Subultimate Ridge |
| 60 | First surface |
| 62 | Second surface |
| 64 | Circumferential edge |
| 66 | Bottom Exterior |
| 68 | Subultimate Apex |
| 70 | Feed Channel |
| 72 | Surface C |

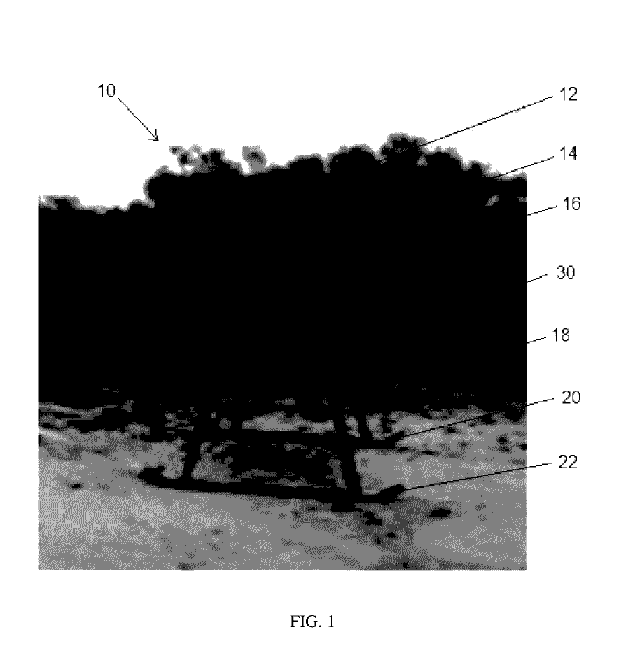

Referring to the figures, FIG. 1 illustrates an embodiment of the improved feeder 10 having four (4) feeding tubes 30. The body of the feeder 10 is generally tubular in shape, that is, it has a hollow interior with a top opening and a bottom opening. The bottom opening is either circular or polyhedral. It is anticipated that the body will be made from a plurality of side plates 16. It is anticipated that there will generally be eight (8) side plates 16 connected along their edges 14 making the upper and lower ends of the feeder 10 octagonal in shape. The feeder 10 has a bottom 50 and a top 12 that are shaped and sized to enclose the interior of the feeder 10 by attaching to the body so as to close the openings of the feeder 10 body. The circumferential edge of the bottom 50 will be generally shaped to match the bottom opening of the feeder 10 body, while the circumferential edge of the top 12 will be generally shaped to match the top opening of the feeder 10 body. It is generally anticipated that the bottom 50 will be attached to the lower ends of the side plates 16 and enclose the bottom opening, and that the top 12 will be removably attached to the upper ends of the side plates 16 and enclose the top opening.

The top 12 will either be removably attached to the feeder 10, or will have an access port or lid (not shown), that allow a user to fill the interior of the feeder 10 with animal feed. It is desirable that the attachment of the top 12, or the access port (not shown), the watertight such that rain and other moisture does not enter the interior of the feeder 10 damaging the animal feed. Thus the top 12 or lid (not shown) may be attached and held removably in place by friction, snap clips, or a number of other similar type attachment devices.

The body (made up of the side plates 16, the bottom 50, and the top 12) of the feeder 10 can be raised to a height appropriate for the species of animal intended to be fed. Thus, the body of the feeder 10 may be supported on a multiplicity of legs 20. One end of the leg 20 is attached to the bottom 50 or the lower end of the side plate 16. The legs 20 may be reinforced or stabilized with support members 18. The leg 20 may be attached to a foot 24 that helps keep the end of the leg 20 from sinking into the earth. In order to make moving the feeder 10 easier, it is anticipated that, alternatively, the legs 20 may be attached to runners or skids 22 opposite the body of the feeder 10.

In one anticipated embodiment of the feeder 10, the side plates 16 are made from 16 gauge sheet steel. The side plates 16 are approximately 36 inches from bottom to top. The legs 20 are made from 12 gauge 1½ inch square tubing. The foot 24 may be made 4×4 inches.

The circular, octagonal, or polyhedral, shape of the feeder 10 is important because it acts to separate the feeding tubes 30 so that feeding animals tend to stay away from one another and there is less conflict between the animals at the feeder 10.

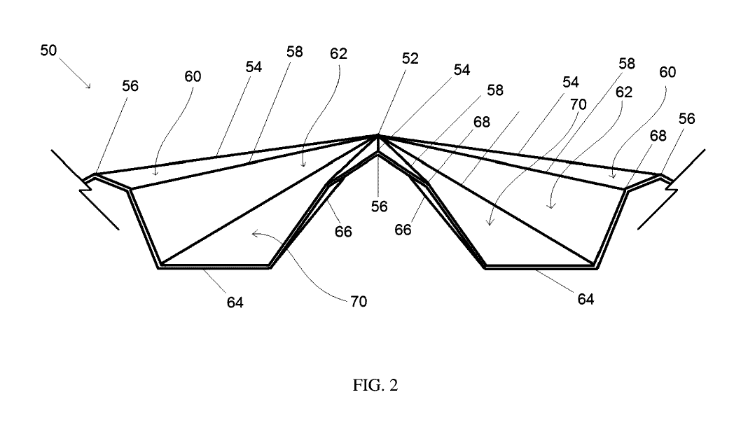

FIG. 2 illustrates the bottom 50 of the feeder 10. FIG. 2 shows a cutaway, side view of the bottom 50 with the remainder of the feeder 10 removed. The bottom 50 may be referred to as an internal cone separator because it is generally cone shaped with an apex 52 near the central axis of the bottom where the central axis runs through the center of the bottom if it was planar, and the bottom having a circumferential edge. As used herein, reference to the cone shape of the bottom 50 also includes a pyramidal shaped bottom where the circumferential edge of the bottom may be either circular or polygonal. When the feeder 10 is positioned for use, and because the bottom has a cone shape, the apex is above the level of the bottom edges of the body and bottom's circumference. The surface of the bottom 50 is not regular or smooth, rather, it is shaped to create chutes for feed placed in the feeder 10 to move out of the feeder 10. From the apex 52, a number of ridges and surfaces run downwardly to circumferential edge 64. The circumferential edge 64 is circular-like or a polyhedron, and generally anticipated to be in octagon shaped and sized to attach to the bottom end of the side plates 16. The intention of the cone shaped bottom 50 is to direct and move animal feed from the interior of the feeder 10 out the tubes 30 to an aperture that allows an animal to access the animal feed. To this end the bottom 50 is shaped with various ridges and surfaces directing the animal feed to slide down to the feed channel 70 and out the feed aperture 44.

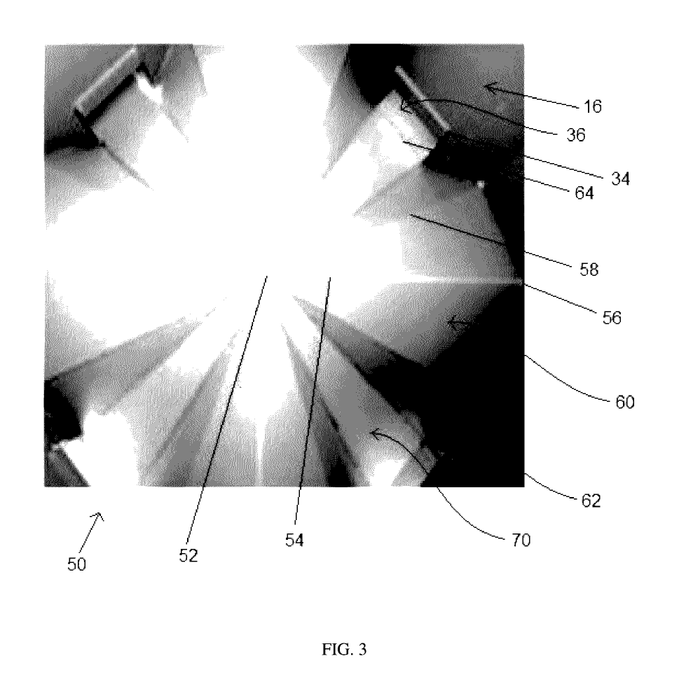

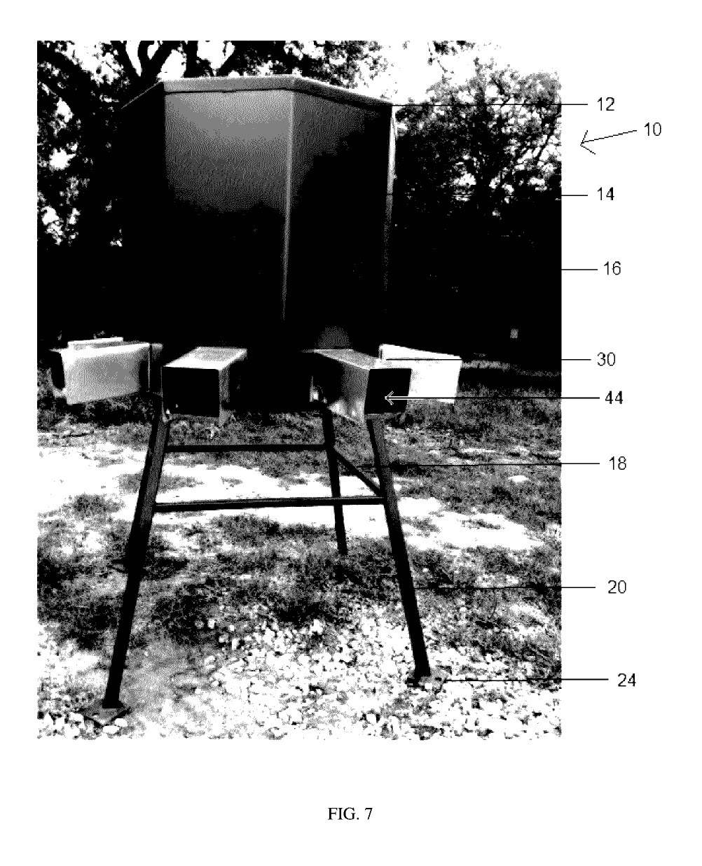

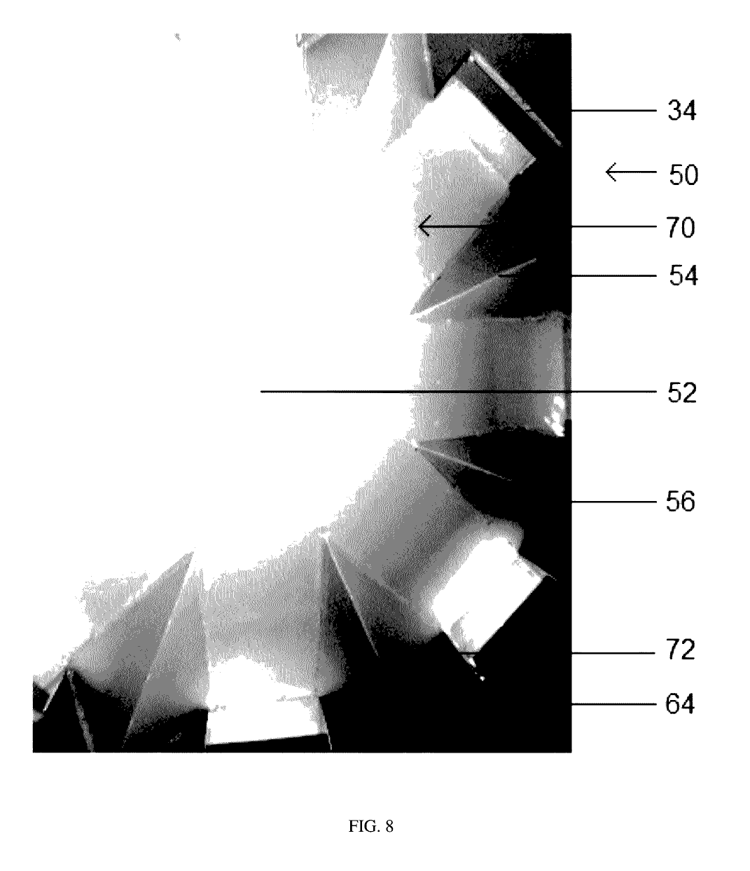

From the apex 52, a multiplicity of top ridges 54 run to the side plates 16, connecting at the ridge apex 56. FIG. 2 illustrates an embodiment of feeder 10 that has four (4) feeding tubes 30. In this embodiment, the planar distance from the top ridge 54 to the feed channel 70 is greater than in an embodiment in which there are more feeding tubes 30 (such as shown in FIGS. 7 and 8). Sloped downwardly from the top ridge 54 is a first surface 60 that ends at subultimate ridge 58. Two first surface's 60 are connected along a first edge to create top ridge 54. The subultimate ridge 58 extends from the apex 52 to the circumferential edge 64 where it connects with a side plates 16. Extending downwardly from subultimate ridge 58 is a second surface 62 that ends at feed plate 36. The second edge of first surface 60 (opposite the edge connected to the second first surface 60) is connected with a first edge of second surface 62. The second edge of second surface 62 is connected with a first edge of feed plate 36. The second edge of the plate 36 is connected with a first edge of another second surface 62. As is shown in FIGS. 2 and 3, there are a multiplicity of these surfaces and ridges extending in a 360° arc to create a full, octagonal (or polyhedral) bottom 50. Each of the surfaces is generally triangular in shape with the apex of the triangle at the apex 52 of the conically shaped bottom 50.

FIG. 3 shows the conically shaped bottom 50 of the feeder 10 from a top view. The embodiment shown in this figure has four (4) feeding tubes 30. This figure shows the ridges and services described above from a top perspective. Shown in this figure is the circumferential edge 64 attached to the side plates 16. Also shown in this figure is the relationship between the feed channel 70 and how it connects with the feed tube 30 through an aperture in the side plate 16. At the top of the aperture is a side plate lip 34. Animal feed is moved by gravity downwardly to the feed channel 70 out through the aperture in the side plate 16 on the feeding plate 36.

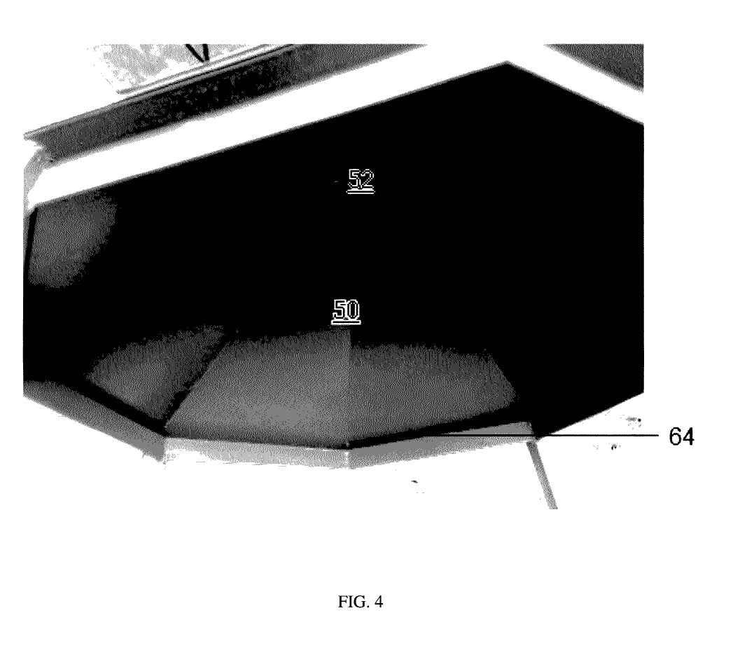

FIG. 4 shows the exterior portion of the bottom 50. The conical shape of the bottom 50 can be seen as figure. Also shown is the apex 52 and the circumferential edge 64 where the bottom 50 is connected to the side plates.

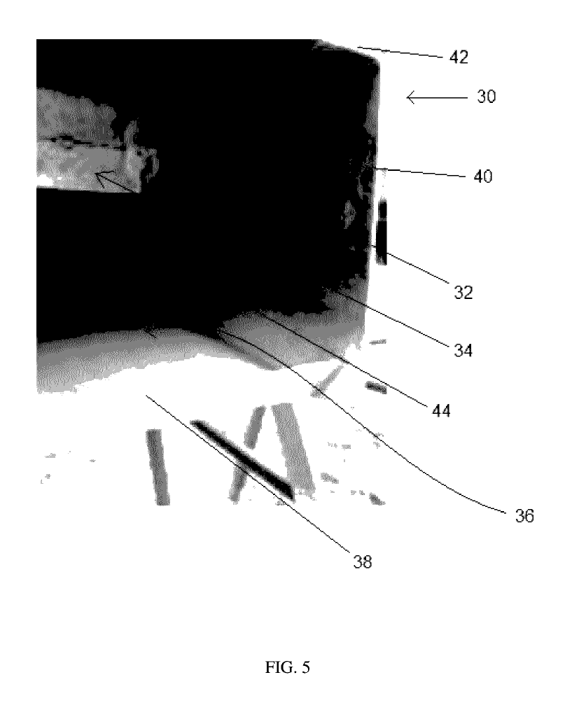

FIG. 5 shows the end and interior of a feeding tube 30. The portion of the feeder tube 30 that is outside the feeder 10 body may be referred to as the outer tube. The hollow tube 30 is created by a feeding plate 36 extending through an aperture in the side plate 16 in forming a bottom of the tube 30. The sides of the tube 30 are formed by two (2) tube sides 40 and a tube top 42. The feeding plate 36, tube sides 40, and tube top 42 are all connected along the edges to create the tube 30. The side plate lip 34 extends downwardly into the aperture in the side plate 16. The front edge 32 of the tube 30 forms an feeding aperture 44 through which an animal may access the animal feed lying on the feeding plate 36. The animal feed is arrested from falling off of the feeding plate 36 and onto the ground by a feed stop 38 which is essentially an upwardly angled lip at the front edge 32 of the tube 30.

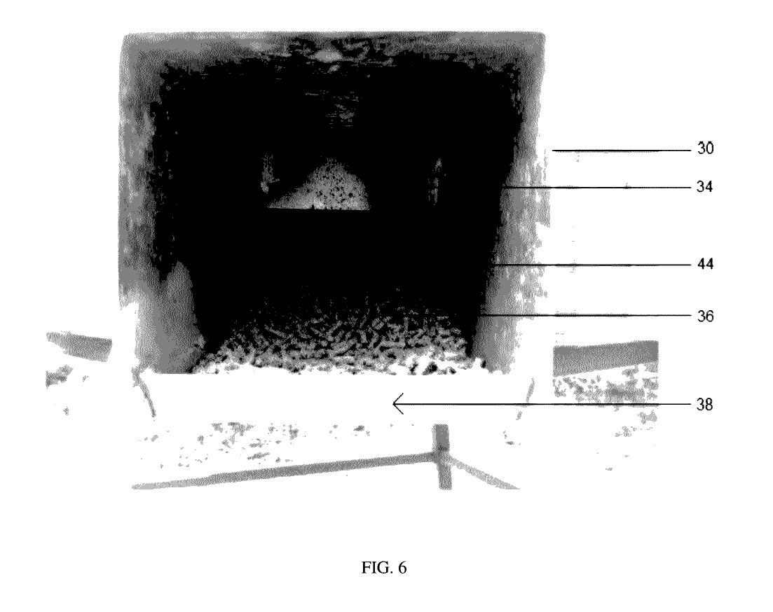

FIG. 6 is a second view of the end and interior of a feeding tube 30. In this figure, animal feed is shown lying on the feeding plate 36. This figure more clearly shows the side plate lip 34 and how animal feed flows under it. It further more clearly shows the feed stop 38 and out it arrests the movement of the animal feed. Finally, this figure illustrates the feed aperture 44 and how an animal accesses the animal feed in the tube 30 and feeder 10.

FIG. 7 shows an embodiment of the improved feeder 10 having eight (8) feeding tubes 30. From the outside, it is essentially as described in FIG. 1 except for the additional feeding tubes 30. Note the angle of the tubes 30 and how the octagon shape facilitates greater spread between the tubes 30 thereby allowing more animals to feed at the feed apertures 44. While it is anticipated that the improved feeder 10 will be used as a deer feeder, the types of animals is not limited to just deer. Also in this figure, instead of skids 22, the legs 20 are shown with a foot 24. The legs 20 and feed 24 are compatible with any of the embodiments of the improved feeder 10 regardless of the number of feeding tubes 30.

FIG. 8 shows the conically shaped bottom 50 of the feeder 10 from a top view (similar to FIG. 3). The embodiment shown in this figure has eight (8) feeding tubes 30. This figure shows the ridges and services described in FIG. 2 from a top perspective. However, because of the additional feeding tubes 30, the distance between the feed channel 70 is reduced. Therefore, the ridges and surfaces have been reconfigured from those shown in FIGS. 2 and 3. In this embodiment, there is only a top ridge 54. Extending downwardly from the top ridge 54 to the feed channel 70 is surface C 72. However, the bottom 50 is still generally conically shaped (as in the four (4) feeding tube embodiment) with the apex 52 being the highest point of the bottom 50 and all of the ridges and surfaces extending downwardly from the apex 52 to the circumferential edge 64.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. An animal feeder for holding and dispensing animal feed, comprising:
a body, wherein said body is generally tubular in shape, having a hollow interior and a top opening and a bottom opening;
a top that is attachable to said body so that it encloses said top opening;
a bottom having a circumferential edge, wherein said bottom that is attachable to said body so that said bottom encloses said bottom opening;
wherein said bottom being generally cone shaped with an apex, wherein when said feeder is positioned for use said apex is positioned above said circumferential edge of said bottom;
a feed channel comprising a pair of opposing ridges that extend from said apex to said circumferential edge of said bottom, a pair of opposing first surfaces one of said first surfaces running downwardly from each of said ridges to a pair of opposing subultimate ridges wherein said subultimate ridges extend from said apex to said circumferential edge of said bottom, a pair of opposing second surfaces one of said second surfaces running downwardly from each of said subultimate ridges to opposing sides of a feed plate, and wherein said second surfaces extend from said apex to said circumferential edge of said bottom;
an aperture in said feeder body near said feeder bottom;
wherein said feed plate extends through said aperture at the bottom of said aperture;
an tube comprising the portion of said feed plate outside said feeder body forming said tube's bottom, two (2) tube sides, and a tube top; and
a feed stop attached to said feeding plate opposite said aperture.

2. The apparatus of claim 1, wherein said body further comprises a multiplicity of side plates and wherein said body top and bottom openings are polyhedral in shape.

3. The apparatus of claim 1, wherein there are a multiplicity of feed channels, with a corresponding number of apertures and tubes.

4. The apparatus of claim 2, wherein there are a multiplicity of feed channels, apertures and tubes corresponding to the number of said side plates.
